(19) United States
(12) Patent Application Publication
(10) Pub. No.: US 2024/0308675 A1
(43) Pub. Date: Sep. 19, 2024

(54) ELECTRIC PROPULSION SYSTEM

(71) Applicant: SKYBRIDGE U.K . LTD., Feltham (GB)

(72) Inventors: Zvonimir SUCIC, Feltham (GB); Maxim PAVILAINEN, Feltham (GB)

(21) Appl. No.: 18/576,004

(22) PCT Filed: Jun. 29, 2022
(86) PCT No.: PCT/GB2022/051673

§ 371 Date: Jan. 2, 2024

(30) Foreign Application Priority Data
Jul. 1, 2021 (GB) 2109507.0

(51) Int. Cl. B64D 27/357; B64D 27/355; B64D 45/00; B64U 50/19; G07C 5/08; H02K 11/00

(52) U.S. Cl. CPC B64D 27/357; B64D 45/00; G07C 5/0816; H02K 11/0094; B64D 27/355; B64D 2045/009; B64U 50/19

(57) ABSTRACT

An electric vehicle propulsion system includes an electric motor and a battery pack formed as a single, integrated unit. It is a self-contained, integrated electric propulsion system. It disrupts the long-established engineering paradigm that the electric motor and the battery pack have to be designed, built and installed as separate systems.

### TECHNICAL FIELD

This disclosure relates to an electric propulsion system, such as a thruster for an electrically powered aircraft.

### BACKGROUND

We are at the start of a multi-year pivot from vehicle propulsion systems based on chemical-combustion (e.g., the internal combustion engine (ICE) used in a car; the jet engine used in a plane) to battery powered electric systems.

One overarching engineering paradigm has applied to conventional chemical-combustion systems for over a century: the fuel or power source is physically separated from the traction system (i.e. the system which causes the propulsion of a vehicle), and they are each designed, built and installed as separate systems.
So a car's petrol tank and the car's ICE are each designed, built and installed as entirely separate systems.
A plane's fuel tank and the plane's jet turbines are each designed, built and installed as entirely separate systems.
A boat's diesel tank and the boat's diesel ICE are each designed, built and installed as entirely separate systems.

And this engineering paradigm has been extended and applied in recent years to battery powered electric vehicles (EVs) too: a car's electric battery pack and the car's electric motors are each designed, built and installed as entirely separate systems. In all cases, some physical interconnect joins the fuel or power source to the traction system—e.g., fuel lines in the case of ICEs and jet turbines that connect to the ICE or jet turbine; high voltage transmission bus bars in the case of EVs that connect the battery pack to the electric motors.

This separation of the fuel or power source from the actual traction system, at the design, build and installation stages, makes engineering sense: at the design stage, different engineering skill sets are needed. At the build stage, the nature of building a fuel tank is fundamentally different from the complex engineering challenges involved in building an ICE or jet turbine. For EVs, the build process of the battery packs has little in common with the build process for an inverter or motor. At the installation stage, because the fuel or power source systems are physically distinct and separate from the traction systems, there is no dependency or linkage in the installation process.

It also makes engineering safety sense; a car's petrol tank is positioned at the opposite end of the car from the engine; a plane's jet fuel tanks are located in the wings, reducing wing stress at take-off and distancing the jet fuel tanks away from the cockpit and any passenger areas. In an EV car, the batteries are usually placed in the chassis, for a lower centre of gravity, improved handling, and because the passenger compartment can then be protected from the battery pack using structural plates.

### SUMMARY OF THE INVENTION

Aspects of the invention are set out by the claims.

An electric vehicle propulsion system includes an electric motor and a battery pack formed as a single, integrated unit. It is a self-contained, integrated electric propulsion system. It disrupts the long-established engineering paradigm that the electric motor and the battery pack have to be designed, built and installed as separate systems.

We can generalise to:

An electric propulsion system that includes a power source and a traction system combined into a single unit that is configured for installation into a vehicle. The power source may include a battery and the traction system may include an electric motor. Further features are listed in Appendix 1.

The term ‘vehicle’ includes aircraft, flying vehicles, air taxis, drones, land vehicles (cars, vans, buses, trucks, lorries, dumper lorries, tractors, diggers, excavators, earth moving machines etc.), boats and submersibles. It also includes high performance vehicles. The term ‘traction system’ refers to the system that provides the propulsive force for the vehicle.

Implementations of the invention exemplify the shift to modularity and component re-use. For example, in the Arrival EV system (see PCT/GB2021/051519, the contents of which are incorporated by reference), modularity is used to enable a ‘Design-Once, Use-Everywhere’ approach, with use across a broad range of different vehicles types. So in the example EV system, there are modular motor units; these motors are designed-once but used across a broad range of different vehicles (e.g., the same motor is used in both cars and vans; in buses, the same motor is paired up and each motor drives a dual-input gearbox for one of the rear wheels). The example EV system includes battery modules: ‘Design-Once, Use-Everywhere’ in whatever numbers are needed to give the required range.

Implementations of the invention apply the modular ‘Design-Once, Use-Everywhere’ engineering approach in a way that disrupts the vehicle design paradigm of keeping batteries as separate systems from the motors they power; instead, in the example system, an electric motor and a battery pack are designed, built and installed as a single, integrated modular unit.

Where the vehicle is an aircraft, flying vehicle, air taxi, drone or boat, the traction system can be a ‘thruster’ system: a thruster system generates propulsion by moving or accelerating mass in one direction; in the case of an aircraft etc. the thruster system will typically include one or more propellers.

Where the vehicle is a car, bus or other land vehicle, the traction system will include one or more traction motors and drive shafts that move the vehicle's wheels or tracks.

### LIST OF DRAWINGS

Embodiments of the invention are described, by way of example only, with reference to the accompanying drawings, in which:

FIGS. 1-2 provide cross-sectional schematic illustrations of a self-powered thruster, with FIG. 1 identifying some integral components of the self-powered thruster, FIG. 2 showing a cross-section from the side;

FIG. 3 provides a perspective view of the self-powered thruster; and

FIGS. 4-5 provide schematic illustrations of a DEP aircraft, with FIG. 4 showing a cross-section from the side, and FIG. 5 showing a cross-section from above.

### DETAILED DESCRIPTION

### A Distributed Electric Propulsion (DEP) System

An example of the present invention is a propulsion system that combines the electric motor with the battery pack, packaging them together into a single, fully integrated unit (which can be referred to as a self-powered propulsion system). This arrangement is especially valuable in aircraft that implement distributed electric propulsion (DEP) systems.

A brief note on DEPs: Electric planes will revolutionise air travel and air cargo; distributed electric propulsion (DEP) systems are a key trend in sustainable vehicle design (See: A Review of Distributed Electric Propulsion Concepts for Air Vehicle Technology, AIAA/IEEE Electric Aircraft Technologies Symposium, Cincinnati, Ohio). But even the most advanced DEP aircraft employ the conventional design paradigm of a centralised battery pack, typically in the plane's fuselage: the battery pack is hence designed, built and installed as an entirely separate system from the electric motors that drive the aircraft propellers; the battery pack connects to the motors via power transmission lines that run through the aircraft.

But an implementation of this invention combines the electric motor with the battery pack, packaging them together into a single, fully integrated unit (which we refer to as a self-powered thruster). And doing so makes a DEP system genuinely ‘distributed’—i.e. the principle of decentralised distribution applies not just to the electric motors and propellers, but also to the batteries too.

This makes the process of DEP vehicle design simpler: the performance consequences of varying the numbers of modular, self-contained, integrated electric propulsion systems is easier to model in simulation because the performance (e.g., lift performance) scales linearly with increasing numbers of integrated, combined battery and motor units; so a drone with lifting capacity X and with Y numbers of self-powered propulsion system can be re-designed as a drone with lifting capacity 5X simply by increasing the number of self-powered propulsion system to 5Y. With a conventional non-DEP architecture, this simple linear relationship is not possible. At one extreme, an DEP aircraft could include just a single self-powered thruster combined battery pack and motor unit for vertical take-off and landing, and perhaps another self-powered thruster combined battery pack and motor unit for normal flight. Or a DEP aircraft that needs 50X the lifting capacity could have an array of 50 or of these self-powered thrusters for vertical take-off and landing.

The self-powered propulsion system also makes DEP vehicles safer since there is no single battery pack for the entire vehicle and hence no central point of failure. Each self-contained, self-powered thruster can be contained within a fire resistant housing (e.g., CMCs, or Ceramic Matrix Composites), so that if one propulsion system should experience a thermal runaway or simply catch fire, that fire will not spread to the other propulsion system(s); again, there is no single point of failure. The vehicle may be lighter, since there is no need for heavy high voltage cabling; this is especially valuable where the vehicle is an aircraft or other type of flying vehicle, where minimising weight is very important.

The same advantages apply to other electric vehicles too, in addition to DEP aircraft; in practice, this approach may well prove to be most useful where power demands are extreme or the EV is a high-performance land vehicle: for instance, in heavy earth moving equipment, where the ability to incrementally add further self-contained, integrated battery-pack and traction motor modules to increase the power can be useful. But even with conventional cars, vans and trucks, particularly when solid-state batteries are commercially manufacturable at reasonable cost, then the significantly greater power to weight ratio and significantly reduced thermal runaway risk of solid-state batteries may well make a fully integrated, combined battery pack and motor unit something that is especially attractive. Even today, with conventional Li-ion batteries, an EV car, van, truck or bus using fully integrated, combined battery pack and motor units, each driving a wheel, is a viable alternative to the long-established skateboard approach of putting a single large battery pack in the chassis: one key advantage is in simplifying the vehicle production process—each fully integrated, combined battery pack and motor unit would be attached, e.g., to a structural wheel arch and there is then no need for a separate battery pack installation process. And by positioning the heavy batteries directly adjacent to the driven wheels, grip is significantly enhanced in snow and ice.

With boats or indeed submersibles, the same advantages apply too: since an electrically powered boat or submersible needs a fully waterproof housing for the motor, inverter and related control electronics, it's especially useful to use a fully integrated, combined rechargeable battery pack and motor unit, since then the entire integrated unit can itself be designed with a waterproof casing, and then drive the propeller through a waterproof coupling.

We will now describe an electric aircraft propulsion system that implements the invention; we describe a thruster that is self-powered by virtue of including a power source (e.g. battery) as well as an electric motor and propeller, all in a single, integrated unit.

The self-powered thruster is modular and is configured to be part of a distributed electric propulsion (DEP) system of a vehicle (e.g., aircraft) made up of multiple self-powered thrusters; the number of self-powered thrusters can be increased or decreased based on design specifications of the vehicle, such as size, and/or weight, and/or required traction force and/or required lifting capacity: the self-powered thruster contributes to the scalability of DEP aircraft design.

To ensure that the vehicle complies with regulatory standards, the location of the vehicle components is carefully selected. Access to components is typically restricted when the component is installed, while being permitted so that maintenance can be safely performed.

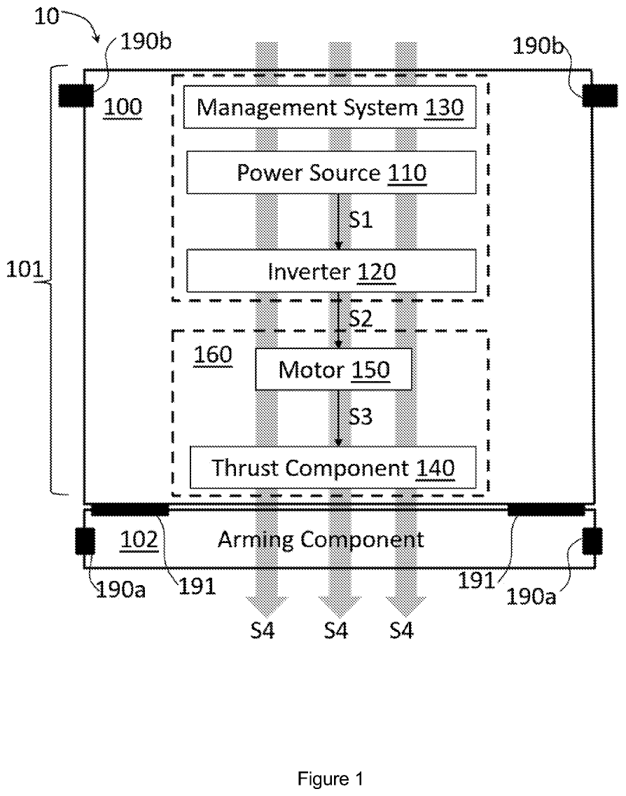

FIGS. 1-3 provide schematic illustrations of the thruster 10. The thruster 10 is formed from a first piece 101 and a second piece 102. The first piece 101 includes an essentially cylindrical housing 100 that encloses power source components (110, 120, 130) (these include the battery packs) and a thrust assembly 160 (e.g. the motor and propeller), thus enhancing safety by keeping the power source components separated from the thrust assembly. The power source components include, for example, one or more power sources (110a, 110b), one or more inverters (120a, 120b), and a management system 130. The thrust assembly 160 is formed of one or more motors (150a, 150b) connected to one or more thrust components (140a, 140b) by one or more drive shafts.

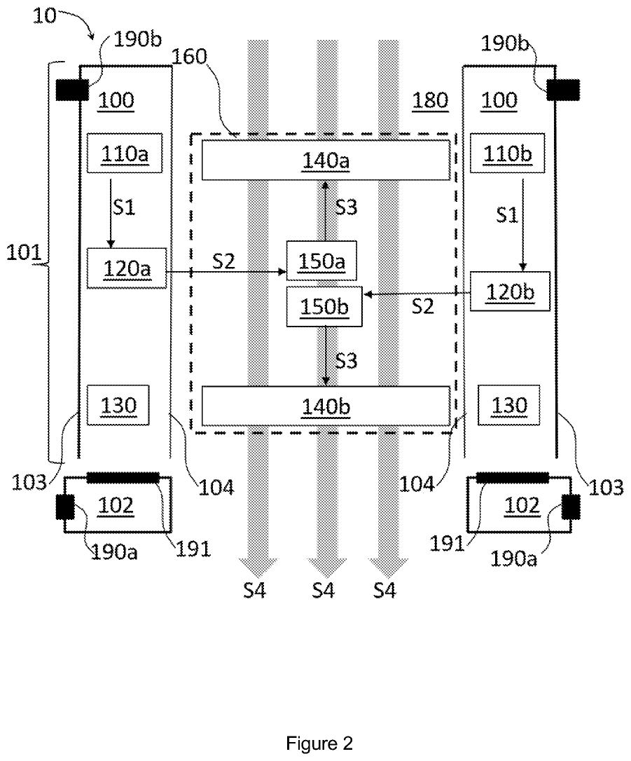

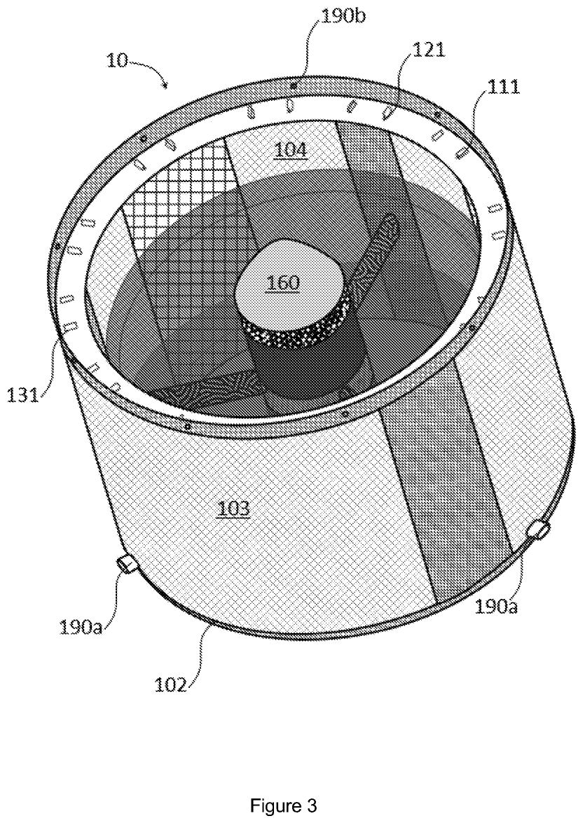

The thruster 10 is configured to serve as a modular component of the vehicle, including all integral features that are used to independently generate high levels of thrust. FIG. 2 illustrates thruster 10 with a thrust assembly 160 that includes two motors (150a, 150b), each of which provides thrusters to a propeller assembly (140a, 140b) comprising propeller blades. The thrust assembly 160 is shown in FIG. 3 including a nose cone 160 configured to reduce air resistance from the motors.

The power source 110 includes a number of battery packs (110a, 110b), each battery pack being formed from a number of cells. The first piece 101 includes the battery packs (110a, 110b) of the power source, with FIG. 3 illustrating an example which includes multiple battery packs. When installed, the second piece 102 connects the battery packs (110a, 110b), for example, in series. A high voltage is achieved by connecting in series the number of battery packs (110a, 110b). Safety is enhanced by connecting low voltage power sources (110a, 110b) in series only once the thruster 10 is fully installed in the vehicle. In this example, safety is enhanced by providing the thruster 10 in two pieces (101, 102), although as an alternative it is possible to configure a thruster in a single piece, for which a series connection between power sources is established using a switch.

The arrows in FIGS. 1-2 show the transfer of energy between the components of the thruster 10. In step S1, direct current is transferred from the one or more power sources (110a, 110b) to one or more inverters (120a, 120b). In step S2, alternating current is transferred from one or more inverters (120a, 120b) to one or more motors (150a, 150b). In step S3, mechanical energy is transferred from the motor(s) (150a, 150b) to the thrust component(s) (140a, 140b). In step S4, each thrust component (140a, 140b) forces fluid (i.e. air) in a direction opposite to the direction of motion of the vehicle. As a consequence, electrical energy stored in the batteries (110a, 110b) is converted into mechanical energy of the vehicle.

FIGS. 1-3 show an example of a thruster 10 that includes a duct that integrates the power components (110, 120, 130), and so this example illustrates features of a self-powered thruster. The housing 100 is configured to surround the thrust assembly 160 to serve as a duct. Providing a duct increases efficiency by reducing propeller blade tip losses, enhances safety by restricting access to moving parts, and contributes to compliance with noise restrictions by absorbing sound. It is not essential for the thruster 10 to include a duct, with other arrangements of the integral components being possible.

The housing 100 includes an outer wall 103 and an inner wall 104, to define an integral void within the housing 100 that is configured to enclose the integral power components. One or more parts of the housing 100 is formed, for example, from one or more composite materials which have been designed having one or more selected attributes (e.g., fire resistance, strength profile). The housing 100 includes a number of fire breaks. The outer wall serves as a fire break 103, thermally isolating the thruster 10 from the rest of the vehicle. The housing 100 includes integral fire breaks, which thermally isolate each of the power components (110, 120, 130). Thus, the housing 100 is configured to contain a fire within the thruster 10, preventing the spread of the fire between components of the thruster, and also preventing the spread of the fire to the rest of the vehicle.

The thruster 10 is self-cooled, including a wall 104 that is positioned between one or more power component (110, 120, 130) and a coolant channel 180. The wall is positioned to protect the power component from an impact force received by the wall 104. The wall 104 has a strength profile that is selected to protect the power components from a collision in the event that a propeller blade of the thrust assembly 140 that has become detached during use. The wall 104 includes layers of material that are configured to dissipate the impact force. One or more parts of the housing 104 are configured to be brought into thermal communication with one or more power component (110, 120, 130), so that during normal use, thermal energy from the power components (110, 120, 130) is transmitted to the coolant channel 180. Situating the power components as part of the thruster enhances efficiency by reducing resistive losses within the electrical connections between the battery packs (110a, 110b) and the motor(s) (150a, 150b).

The thruster 10 is designed to withstand a thermal runaway, with the wall 104 being arranged to be sacrificed if a temperature of one or more power components (110, 120, 130) exceeds a threshold value. During an emergency in which a threshold temperature has been exceeded, the housing 100 is configured to increase the convection cooling of the power components, so that their thermal energy is dissipated to the coolant channel 180. The sacrificing of the wall 104 allows a fire to be directed through the coolant channel 180 and away from the rest of the vehicle. Thus, the temperature of the power components (110, 120, 130) is reduced, and the fire can be kept under control until it has been extinguished.

A support structure provides a physical connection, an electronic connection, and a data connection between the power components (110, 120, 130) and the thrust assembly 160. The support structure of the thruster holds one or more motors (150a, 150b) in place relative to the power sources (110a, 110b). The support structure includes one or more cables configured to provide an electrical connection between the power source 110 and the motor(s) 150. The support structure includes power cables configured to transfer electrical power from the inverter(s) 120 to the motor(s) 150. The support structure includes data cables configured to transfer sensor data from the motor(s) to the BMS 130. In operation, the thruster 10 is configured to monitor its own condition using integral sensors.

The thruster 10 includes a management system 130 configured to monitor a condition of the thruster, and a communication system 130 configured to communicate with the vehicle. In use, the management system 130 receives data from a number of sensors. Resulting sensor data is analysed by the management system 130, and reports on the condition of the thruster 10 are provided to the vehicle by the communication system 130. The vehicle uses reports on the condition of each of the thrusters to determine how the thrusters are to be used. During normal operation, the management system 130 executes instructions that the communication system 130 has received from the vehicle. The thruster is configured to operate in an autonomous mode, for example, in the event of an emergency or if communication with the vehicle is not available. The extent of autonomous operation of the thruster 10 is selected to ensure compliance with regulatory standards.

One or more motors (150a, 150b) are arranged to be coaxial with one or more thrust component (140a, 140b), which enhances efficiency due to the simplicity of their mechanical coupling. Each thrust component 140 (e.g., propeller/impeller) is configured to rotate around its corresponding motor 150, in the same plane as the motor 150, which reduces the height profile, thus reducing drag for motion of the vehicle that is perpendicular to the axis of rotation. Accordingly, specifications of the thruster 10 (e.g., its height) can be selected to take account of other vehicle components, such as other thrusters that are installed in the vehicle.

The thruster 10 includes a drive shaft which is configured to transmit mechanical energy from one or more motors (150a, 150b) to one or more thrust components (140a, 140b), the drive shaft including one or more coolant channel that passes through the motors (150a, 150b). Providing each motor 150 with a number of integral cooling channels enhances their rate of cooling. The thrust component (140a, 140b) is configured to retrieve propellant and coolant from the external environment, which means that the vehicle does not have to carry propellant and coolant, which would contribute to the weight of the vehicle. The same fluid serves as both the propellant and coolant, which typically is air where the vehicle is an aircraft (or water if the vehicle is a boat or submersible), depending on the application of the thruster 10.

FIGS. 2-3 illustrate an example of a thrust component that includes two counter-rotating propellers (140a, 140b). The two propellers rotate about a common axis of rotation. The torque experienced by the thruster 10 is balanced by rotating both propellers at the same angular speed in opposite directions. A torque is selected by rotating the propellers at different speeds, with thrust being maintained by increasing the speed of rotation of one of the propellers, while decreasing the speed of rotation of the other propeller.

Many components of the thruster 10 are designed for an installation path to a final position, in which the installation path is optimised for robotic handling, installation or assembly. The robots are calibrated to follow a routine of moving the components into place and perform production techniques using specialised tools. This production technique is illustrated by the thrust component (140a, 140b), which is configured to be balanced after it has been installed in the thruster 10, when the thruster 10 has been partially or fully assembled. A possible way to balance each thrust component 140 in an automated process is by measuring rotation of the thrust component 140 using an accelerometer and a camera to determine where weight should be added to the thrust component 140. Balancing the thrust component 140 after it has been installed in the thruster 10 provides an assembly process that accommodates tolerance.

Each of the power components (110, 120, 130) includes physical connectors (111, 121, 131) which serve to provide an attachment to the housing 100. FIG. 3 illustrates the physical connectors (111, 121, 131) as male extrusions that are configured to hold in place the power components (110, 120, 130) by slotting into corresponding holes provided in an upper surface of the housing 100.

One or more fasteners (190a, 190b) of the thruster releasably attach the thruster to a corresponding fastener of the vehicle, which simplifies servicing of the vehicle, because a thruster can be easily repaired or replaced. The second piece 102 establishes the series connection between the battery packs (110a, 110b) at the same time as each fastener 190a of the thruster 100 becomes releasably attached to the corresponding fastener of the vehicle. The second piece 102 includes an actuator configured to move a number of fasteners 190a, from a retracted position to a deployed position, thus facilitating installation and removal of the thruster 10. As an example of a releasable fastener, the thruster is attached to the vehicle by nuts and bolts, with the thruster 10 including bolt holes 190b configured to receive the bolts. The second piece 102 includes a number of connectors 191 arranged to form a physical connection, an electronic connection, and a data connection with the first piece 101. The thruster 10 is not restricted to having the fasteners shown in FIG. 3, which illustrates a fastener 190a as a male member of the second piece 102 which when actuated is configured to become physically connected to the first piece 101 by passing through a hole in the outer wall 103 of the housing 100, and then be received by a void of the vehicle fuselage. Thus, disclosure is provided of a simple and easy attachment mechanism of the thruster, although other alternatives are available, such as a thruster configured to be inserted and twisted into place, or a thruster that is configured to be fixed in place as part of the vehicle.

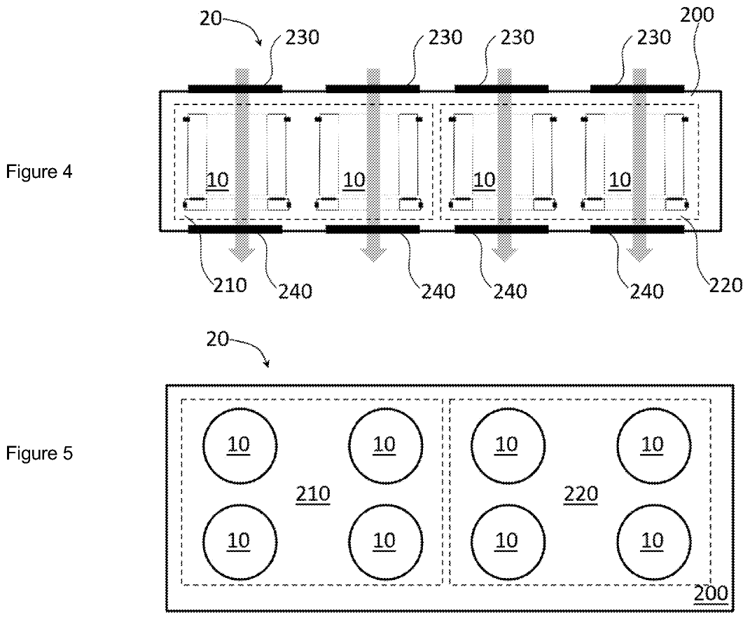

FIGS. 4-5 show a vehicle 20 that is installed with a number of thrusters 10, to provide a distributed electric propulsion system. Such vehicles typically serve as members of a fleet. For the example shown, a fuselage 200 of the vehicle includes clusters (210, 220) which are installed with thrusters 10. The fuselage includes covers (230, 240) that are configured to open during operation of the thruster 10, and close when the thruster 10 is not operating.

The thruster 10 is configured to be installed in different types of vehicles, including aircraft, watercraft, and land vehicles. The thruster 10 contributes scalability and flexibility to vehicle design, serving as a modular component that is accommodated by vehicles having a variety of shapes (e.g., an aerofoil shape, a blended wing). The attributes of the vehicle 20 determine attributes that are selected for the thrusters that are installed, such as their height, diameter, strength profile, etc. The covers (230, 240) are optional, being provided to move between an open position and a closed position, to cover the thrusters when not in use. The covers serve as louvres (230, 240), so that drag forces are restricted by maintaining a boundary layer of the fuselage when the thrusters are not in use. The use of covers (230, 240) is not essential, because as an alternative, it is possible for the boundary layer to be maintained by activating the thrust component of the thruster

When installing a vehicle 20 with a thruster 10, the first piece 101 is installed, and then the second piece 102 is installed. The arming component 102 of the thruster is installed after the power source 110 has been installed. When removing a thruster from the vehicle, the arming component 102 is removed before the power source 110 of the thruster is removed. Electrical safety is enhanced because individual battery packs (110a, 110b) are kept electrically isolated when the arming component is not installed. For example, the vehicle is configured so that the thruster 10 can be installed or removed from below. Installation or removal of the thruster is performed using actuators that are located in the base of the second piece 102, that are configured to move the connectors 191 between a deployed position and a retracted position.

The simplicity of attaching and detaching the thrusters means that they can easily be replaced, which reduces maintenance costs of the vehicle.

The scope of the claims is not restricted to the examples that have been described, as it will be understood that many variations and modifications are possible. Any of the optional features described herein may be readily combined with any of the other features. The following list of key features forms part of the description.

### APPENDIX 1—KEY FEATURES

We have seen earlier that the invention, as defined by the claims, relates to an electric propulsion system that includes a power source and a traction system combined into a single unit that is configured for installation into a vehicle. We can think of this propulsion system as being ‘self-powered’ in the sense that it is a propulsion system that includes it's own integral power source, all contained within a single unit.

Where the vehicle is an aircraft, the power source will typically include a battery and the traction system can then be an electric motor and propeller. So in this case, the propulsion system includes, all in a single unit, both the electric motor and propeller, and also the electric battery(ies) that power the motor. Normally, the electric batteries would be physically separate from the traction system and provide electric power over a power cable—i.e. the electric batteries, electric motor and propeller are not all combined into a single unit. But, as we have seen earlier, integrating the power source together with the traction system into a single unit gives many advantages.

The following are optional or additional key features; note that any one or more of these key features can be combined with any one or more other key features.
1. The self-powered propulsion system is single-unit propulsion system component, which is both modular & scalable:
   The conventional approach is to have several, separate independent components (battery; inverter; motor; propellers; structures), which are individually housed, joined together with power/communication cabling etc which can be both heavy and expensive.
   The self-powered propulsion system is a single unit traction or thrust component which contains all of the sub-systems needed to independently generate high levels of thrust or traction (battery, inverter, motor, BMS, propeller/impeller, arming ring).
   Each self-powered propulsion system is a modular, independent unit. Any number of self-powered propulsion systems can be used in combination with each other, e.g., 2, 3, 4, . . . or even 16, 20, 40, 60, 80, 100, etc. . . . self-powered propulsion systems can be used on a single electric vehicle. This gives the ability for the vehicle designer to scale up and design any electric vehicle they want.
   There is also the potential for independent, modular units to be used in this way for air, sea and land applications.
   A key advantage of the self-powered propulsion systems approach is that it is scalable and flexible, so that it is possible to create different levels of thrust/power for any size or type of vehicle.
   Another key advantage of the self-powered propulsion systems approach is that thrust/power functionality is decentralised across the vehicle. This means the electric vehicle will have several thrust units across the vehicle upon which it can rely. Because self-powered propulsion systems are modular and scalable, it is possible to have a large array of these systems; self-powered thruster arrays can form a significant part of the fuselage of a blended wing (by way of example only, an array of, e.g., 60-100 self-powered thrusters is possible for a large blended wing aerial vehicle).
   Another key advantage is improved safety and lifetime of the electric vehicle, because each self-powered propulsion system unit can be easily replaced or discarded if needed (e.g., if it becomes unsafe or malfunctions), which increases the overall life/use of the electric vehicle.
2. The self-powered propulsion system has a simple modular design, and it can be easily attached/detached from the electrical vehicle:
   Each Self-powered propulsion system has a standard overall design, which is safe and simple to handle.
   The Self-powered propulsion system has a simple, modular design (e.g., the electrical interface may be very simple: such as communication and trickle charging port only).
   The Self-powered propulsion systems is safe to handle because the arming ring disconnects low voltage battery modules from each other and transforms the high voltage battery pack into several low voltage battery modules.
   The mechanical & electrical connections between the self-powered propulsion system(s) and electric vehicle have a simple and elegant design which is easy to operate. It means non-specialist technicians can easily replace, remove, add complete Self-powered propulsion systems.
   There is also an improvement in the overall safety and lifetime of the electric vehicle because Self-powered propulsion systems can be removed or replaced easily.
   The source of battery power is not critical; in fact, the Self-powered propulsion system may use conventional Li-ion cells; or pouch cells; or hydrogen fuel cells; or solid-state cells; etc.
   There is a simple and easy attachment and detachment mechanism: e.g., insert Self-powered propulsion system and twist it; arming ring with a number of retractable pins.
3. The Self-powered propulsion system does not cause destruction/disposal of the entire vehicle in the event of fire:
   With any electrical vehicle, the biggest fire risk comes from overheating of the batteries and/or battery units/packs.
   In conventional vehicles, in practice this means a large portion of the vehicle catches alight and effectively the entire vehicle is sacrificed (which is inconvenient and extremely costly).
   With the Self-powered propulsion system, the risks to the vehicle in the event of fire are greatly reduced. First, because the battery power is distributed across the vehicle. Secondly, because the outer wall of each self-powered unit is composed of a highly fire resistant material, e.g. a composite material which does not alight easily, even at very high temperatures. The fire can therefore be controlled/contained to the individual Self-powered propulsion system.
   In practice this means that if a Self-powered propulsion systems does catch fire, only the individual Self-powered propulsion systems will be lost or sacrificed, not the entire vehicle. This is a very powerful feature because it allows the vehicle to continue operating rather than being sacrificed or lost.
4. The Self-powered propulsion system can operate as an independent, autonomous module:
   Each Self-powered propulsion systems can operate autonomously, e.g., alert the electric vehicle or main control unit if it becomes unsafe or malfunctions.
   Potential autonomous features of the Self-powered propulsion systems could include: reporting its own status to the central control and/or vehicle; deliver autonomous power; Self-powered propulsion system doesn't shut itself down unless there is a critical error; if there is a critical error then the Self-powered propulsion system will shut itself down; autonomous attachment or detachment of the Self-powered propulsion system to the vehicle under certain specified conditions.
5. The Self-powered propulsion system has integrated ‘smart’ software features:
   The BMS system can be used to monitor the status of individual battery cells or packs or pouches (e.g., voltage, charge, temperature).
   Two-way communications may be possible with, e.g., the electric vehicle or main control unit, or other Self-powered propulsion systems.
   Authentication/security features and procedures, two-way handshake, etc.
   Security features to ensure only genuine Self-powered propulsion systems are used on vehicles, not counterfeit Self-powered propulsion systems and vice-versa.
   Performance reporting back to the electric vehicle.
   Self-powered propulsion systems which autonomously negotiates with other Self-powered propulsion systems.
   Self-powered propulsion systems with crypto-networks.
   Self-powered propulsion systems which self-initialises.
   Each Self-powered propulsion systems can autonomously determine its physical position in the vehicle; there is an address coding inside of the harness; when plugging in the Self-powered propulsion systems, it knows which position it is at from this address.
6. The Self-powered propulsion system has a highly efficient design because the integral power components (batteries, inverters) are arranged in a duct:
   There may be a number of low voltage battery modules within the Self-powered propulsion systems. Each low voltage battery module is independent from one another (without the arming ring).
   These low voltage battery modules are only connected to provide a high voltage once the Self-powered propulsion systems has been fully installed in the vehicle.
   Where the vehicle is an aircraft, then the propulsion system is formed in a duct: the duct may be for example tubular or cylindrical in shape. The power components (e.g., one or more of the inverters, the BMS, and the low voltage battery modules) may provide structural integrity for the duct. For example, a main load bearing path could be provided through the inverters and BMS, so that the battery modules are non-stressed while contributing to the strength of the duct.
   The power components may be convection cooled, by virtue of being part of or in the duct. The height of the duct can also be selected according to the vehicle specifications, which helps to reduce air resistance during motion of the vehicle.
   The duct enhances efficiency by reducing propeller blade tip losses, enhances safety by restricting access to moving parts, and enhances compliance with noise restrictions by absorbing sound.
7. The Self-powered propulsion system improves overall safety of the electrical vehicle:
   The Self-powered propulsion system may include a sacrificial wall positioned between the power components and the interior surface of the system. If the temperature of the power component exceeds a threshold, then the sacrificial wall is discarded, so that convection cooling (especially where the vehicle is an aircraft) of the power component is increased.
   The Self-powered propulsion system may also include an arming mechanism. The Self-powered propulsion systems is only electrically armed when it is fully installed in the vehicle. Electrical safety is enhanced because individual low voltage battery modules are kept electrically isolated when the arming mechanism is not installed.
8. The Self-powered propulsion system is designed for Robofacturing:
   The Self-powered propulsion system is specifically designed and configured for robotic handling, installation and assembly—e.g. some or all parts, wiring etc are designed for robotic handling, installation and assembly.
   The number of individual parts and components which make up the Self-powered propulsion system is minimised and simplified in order to enable more efficient robofacturing of the Self-powered propulsion system.
   The Self-powered propulsion system may be comprised of extruded parts and components (as far as possible) to allow easier machine handling.
   Manual assembly of the Self-powered propulsion system is also possible albeit this is likely to be less time and cost efficient.

### Thruster Concepts

In this section, we outline some of the thruster concepts implemented in one embodiment.

1. A thruster (10) configured to form part of a distributed electric propulsion system for a vehicle (20), the thruster (10) including:
a power source (110),
a thrust component (140), and
a motor (150) arranged to convert electrical energy which is received from the power source (110) into mechanical energy which is transmitted to the thrust component (140).

2. A thruster (10) according to concept 1, the thruster further including a housing (100) configured to be installed with one or more power component (110, 120, 130) of the thruster (10).

3. A thruster (10) according to concept 2, wherein one or more part of the housing (100, 104) is configured to be brought into thermal communication with the one or more power component (110, 120, 130).

4. A thruster (10) according to concept 2 or concept 3, wherein the housing (100) is configured to surround the thrust component (140) to serve as a duct.

5. A thruster (10) according to any preceding concept, the thruster further including a wall (104) positioned between one or more power component (110, 120, 130) and a coolant channel (180).

6. A thruster (10) according to concept 5, wherein the wall (104) is configured to be sacrificed if a temperature of the one or more power components (110, 120, 130) exceeds a threshold value.

7. A thruster (10) according to concept 5 or concept 6, wherein the wall (104) is configured to protect the power component from an impact force received by the wall (104).

8. A thruster (10) according to any preceding concept, the thruster further including a fire break (103) configured to thermally isolate from one another the thruster (10) and the vehicle (20).

9. A thruster (10) according to any preceding concept, the thruster further including a fire break configured to thermally isolate from one another a first power component (110, 120, 130) and a second power component (110, 120, 130).

10. A thruster (10) according to any preceding concept, the thruster further including a fastener (190a, 190b) configured to be releasably attached to a corresponding fastener of the vehicle (20).

11. A thruster (10) according to any preceding concept, the thruster further including a first piece (101) comprising a number of battery packs (110a, 110b) of the power source, and a second piece (102) configured to connect the battery packs (110a, 110b) in series.

12. A thruster (10) according to concept 11 when dependent on concept 10, wherein the second piece (102) is configured to establish the series connection between the battery packs (110a, 110b) at the same time that the fastener (190a) of the thruster (100) becomes releasably attached to the corresponding fastener of the vehicle (20).

13. A thruster (10) according to any preceding concept, the thruster further including a management system (130) configured to monitor a status of the thruster (10), and a communication system (130) configured to report the status of the thruster (10) to a control system of the vehicle (20).

14. A thruster (10) according to any preceding concept, wherein the motor (150) is coaxial with the thrust component (140).

15. A thruster (10) according to any preceding concept, wherein the thrust component (140) is configured to retrieve propellant and coolant from the external environment.

16. A thruster (10) according to any preceding concept, the thruster further including a drive shaft configured to transmit mechanical energy from the motor (150) to the thrust component (140), the drive shaft including one or more coolant channel that passes through the motor (150).

17. A thruster (10) according to any preceding concept, wherein a plurality of components of the thruster (10) are designed for an installation path to a final position, in which the installation path is optimised for robotic handling, installation or assembly.

18. A thruster (10) according to any preceding concept, wherein the thrust component (140a, 140b) is configured to be balanced after it has been installed in the thruster (10) when the thruster (10) has been partially or fully assembled.

19. A thruster (10) according to any preceding concept, the thruster further including a support structure configured to hold the motor (150) in place relative to the power source (110), wherein the support structure includes one or more cable configured to provide an electrical connection between the power source (110) and the motor (150).

20. A vehicle (20) including a distributed electric propulsion system configured to be installed with a number of thrusters (10), each thruster (10) according to any preceding concept.

1. An electric propulsion system that includes a power source and a traction system combined into a single unit that is configured for installation into a vehicle, in which the single unit is modular and configured to enable a scalable number of such single units to form a distributed electric propulsion (DEP) system, where the number of such units depends on the size, and/or weight, and/or required traction force and/or required lifting capacity of the vehicle, in which the vehicle is any of the following: an aircraft, flying vehicle, air taxi and drone.

2. The propulsion system of claim 1 which is self-powered in that it includes in the single unit all sub-systems needed to store electrical energy and to convert that electrical energy into propulsive force.

3. The propulsion system of claim 1 which is self-powered in that it includes in the single unit all sub-systems needed to store electrical energy and to convert that electrical energy into propulsive force without needing power from any source external to the unit.

4. The propulsion system of claim 1 that is self-powered in that it includes in the single unit a battery pack, an electric motor powered by the battery pack, and a propeller driven by the electric motor.

5. (canceled)

6. The propulsion system of claim 1 in which the single unit is modular, and configured to be installed and removed from a vehicle as a complete unit.

7-9. (canceled)

10. The propulsion system of claim 1 in which a wall of a unit is composed of a highly fire resistant material.

11. The propulsion system of claim 1 in which a wall of a unit is composed of a sacrificial material designed to be sacrificed in the event of over-heating in the unit to increase convection cooling of the unit.

12. The propulsion system of 1 which is self-contained in that it does not need power from any power source external to the unit.

13. The propulsion system of 1 which is configured to operate autonomously and to alert the vehicle or a main control unit in the vehicle if it becomes unsafe or malfunctions.

14. The propulsion system of 1 which is configured to monitor and to report its own status to a central control and/or vehicle.

15. The propulsion system of 1 which is configured to only shut itself down if there is a critical error.

16. The propulsion system of 1 which includes a BMS (battery management system) configured to monitor the status of individual battery cells or packs or pouches (e.g., voltage, charge, temperature).

17. The propulsion system of 1 which is configured for two-way communications with one or more of the vehicle; a main control unit; other propulsion systems.

18. The propulsion system of 1 which is configured with authentication or security features and procedures to enable secure communications with one or more of the vehicle; a main control unit; other propulsion systems.

19. The propulsion system of 1 which is configured to report performance data back to the vehicle.

20. The propulsion system of 1 which is configured to autonomously negotiate with other self-powered propulsion systems in the vehicle.

21. The propulsion system of 1 which is configured to autonomously self-initialise.

22. The propulsion system of 1 which is configured to autonomously determine its physical position in the vehicle.

23. The propulsion system of claim 1 which is configured to electrically self-arm only when it is fully installed in the vehicle.

24. The propulsion system of 1 in which the power source includes a battery.

25. The propulsion system of 24 in which the battery is a rechargeable battery such as a Li-ion battery.

26. The propulsion system of 24 in which the battery is a solid state battery.

27. The propulsion system of 1 in which the power source is a fuel cell, such as a hydrogen fuel cell.

28. The propulsion system of 1 in which the traction system includes an electric motor.

29. The propulsion system of 1 in which the traction system is a thruster system.

30. (canceled)

31. The propulsion system of 29 in which the thruster system includes one or more propellers.

32. The propulsion system of 29 in which the thruster system is contained within an air duct.

33. The propulsion system of 32 in which the duct is tubular or cylindrical in shape.

34. The propulsion system of 32 in which the unit includes power components, such as one or more of inverters, the BMS, and low voltage battery packs, and in which the arrangement of the power components provide structural integrity for the duct.

35. The propulsion system of 34 in which the power components are convection cooled, by virtue of being part of or in the duct.

36-37. (canceled)

38. The propulsion system of 1 in which the vehicle is an aircraft and a boundary layer over the propulsion system is maintained by closing or part closing a cover over the propulsion system.

39. The propulsion system of 29 in which the vehicle is an aircraft and a boundary layer over the propulsion system is maintained using the thrust of the thruster system when the propulsion system is activated.

40-42. (canceled)

43. A vehicle that includes an electric propulsion system as claimed in claim 1.
